(19) United States
(12) Patent Application Publication
(10) Pub. No.: US 2006/0010381 A1
(43) Pub. Date: Jan. 12, 2006

(54) Method for visually indicating the quality of on-screen help messages

(75) Inventors: Mark E. Molander, Cary, NC (US); Sandra D. Kipp, Raleigh, NC (US); Erik F. Hennum, San Francisco, CA (US); David A. Sawin, Tucson, AZ (US)

Correspondence Address: Frank C. Nicholas;CARDINAL LAW GROUP, Suite 2000, 1603 Orrington Avenue, Evanston, IL, 60201, US

(73) Assignee: International Business Machines Corporation, Armonk, NY (US)

(21) Appl. No.: 10/886,301

(22) Filed: Jul. 7, 2004

(51) Int. Cl. G06F 3/00

(52) U.S. Cl. 715/707; 715/708

(57) ABSTRACT

A method in a data processing system for providing a user of the system with a visual indication of a quality of one or more features of an on-screen help message (e.g., a usefulness, an importance, or a content level of the message). The method involves a generation of a graphical help interface (e.g., a graphical indicator of usefulness within a button)) to visually indicate the quality of the feature(s) of the on-screen help message, and a display of the graphical help interface in a display window associated with the on-screen help message. The method can further involve a customization to the user by the data processing system of one or more of the features of the on-screen help message that are visually indicated by the graphical user interface, and/or one or more additional features of the on-screen help message that are not visually indicated by the graphical user interface.

### FIELD OF INVENTION

The present invention generally relates to on-screen help messages (e.g., instructions and warnings). More particularly, the present invention relates to a method for visually indicating the quality of one or more features of an on-screen help message (e.g., a usefulness, an importance and/or a content level of the message).

### BACKGROUND OF THE INVENTION

Typically, there is a seam in software user interfaces between the primary interaction on the panels, such as, for example, filling in the fields of a form, and the associated help. Although full help systems can be quite powerful, they are not often likely to be useful. In instances where the help is not well integrated with the main flow, help systems can take the user off of a task. Sometimes users will select for help and get a fairly useless boiler-plate non-informative help message that leads users to give up on the help system. Consequently, users do not always take advantage of rich help systems. This will limit the value they receive from the software and/or increase the time required for completing a function.

It is therefore desirable for the user to have a seamless software interface with a visual indication of the quality of on-screen help messages.

### SUMMARY OF THE INVENTION

One form of the present invention is a method in a data processing system for providing a user of the data processing system with a visual indication of a quality of a feature of an on-screen help message. The method involves a generation of a graphical help interface as a visual indication of a quality of one or more features of the on-screen help message, and a display of the graphical help interface in a display window associated with the on-screen help message.

A second form of the present invention is a signal bearing medium tangibly embodying a program of machine-readable instructions executable by a processor to perform operations to visually indicate a quality of a feature of an on-screen help message. The operations involve a generation of a graphical help interface as a visual indication of a quality of one or more features of the on-screen help message, and a display of the graphical help interface in a display window associated with the on-screen help message.

A third form of the present invention is a data processing system employing a display, a processor and memory storing instructions operable with the processor for visually indicating a quality of a first feature of an on-screen help message. The instructions are executed for generating a graphical help interface as a visual indication of a quality of one or more features of the on-screen help message, and for displaying the graphical help interface in a display window associated with the on-screen help message.

The forgoing form and other forms, objects and aspects as well as features and advantages of the present invention will become further apparent from the following detailed description of the presently preferred embodiments, read in conjunction with the accompanying drawings. The detailed description and drawings are merely illustrative of the present invention rather than limiting the scope of the present invention being defined by the appended claims and equivalents thereof.

### BRIEF DESCRIPTION OF THE DRAWINGS

FIG. 1 illustrates a schematic of a conventional display window as known in the art;

FIGS. 2-12 illustrate schematics of exemplary display windows having levels of help for various roles and levels of expertise in accordance with the present invention;

FIG. 13 is a schematic diagram of a network of distributed data processing systems as known in the art for practicing the present invention as known in the art for practicing the present invention;

FIG. 14 is a schematic diagram of a typical computer architecture of a data processing system as known in the art for practicing the present invention;

FIG. 15 illustrates a flow chart representative of one embodiment of a method of user selection of role and expertise level in accordance with the present invention; and

FIG. 16 illustrates a flow chart representative of one embodiment of a method of dynamically updating on-screen help messages in accordance with the present invention.

### DETAILED DESCRIPTION OF THE PREFERRED EMBODIMENTS

The present invention will now be described more fully hereinafter with reference to the accompanying figures, in which preferred embodiments are shown. This invention may, however, be embodied in many different forms and should not be construed as limited to the embodiments set forth herein. Like number refer to like elements throughout.

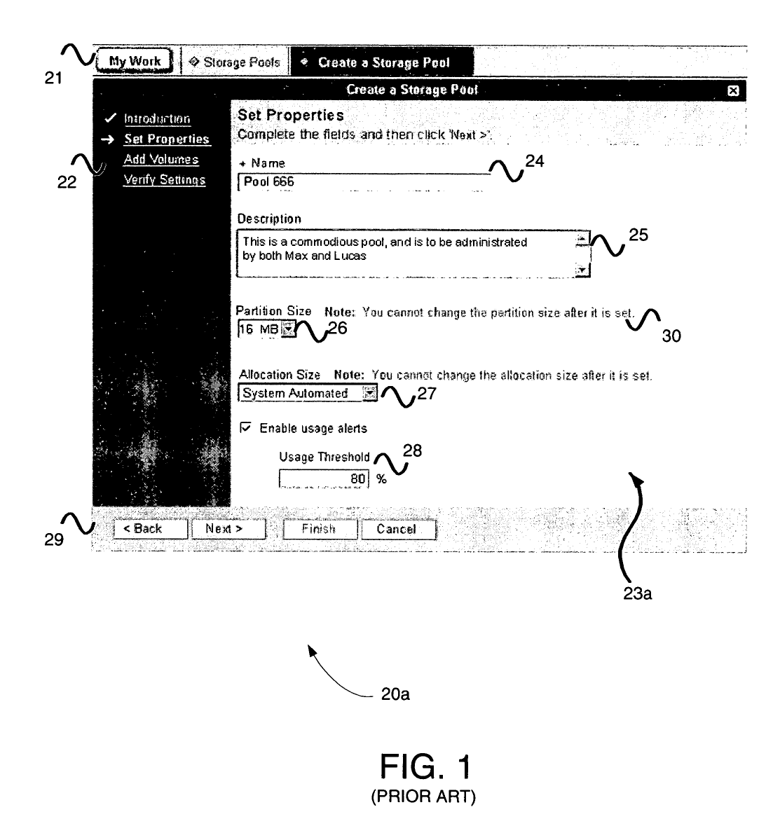

FIG. 1 is a schematic of a conventional display window 20a including a tab navigation frame 21 to allow a user to navigate through various display windows (e.g., display window 20a), and a panel area interface 22 to identify a panel being displayed by display window 20a, such as, for example a panel 23a as shown. Panel 23a displays a name control 24, a description control 25, a partition size control 26, a allocation size control 27 and user threshold controls 28. Controls 24-27 are fields in which a user enters input. A user control interface 29 provides buttons (e.g., BACK and NEXT as shown) to allow a user to navigate through various panels (e.g., panel 23a).

A partition size help feature 30, adjacent to partition size control 26, indicates a warning to the user that the partition size cannot be change after it is set. This warning clutters panel 23a and detracts from the visual impact of display window 20a. Since this warning is important, it is highly useful for a user to be instructed about this limitation prior to first use. Conversely, a user does not need to see the warning once the user is familiar with this limitation. However, partition size help feature 30 is static in panel 23a and will be indicated each time display window 20a is displayed.

To overcome the shortcomings of help feature 30, the present invention provides a new and unique visual indication method that indicates the quality of one or more features of an on-screen help message (e.g., an instruction or warning) by providing a quality coded graphical help interface to the message (e.g., an icon or a pull-down window) that is indicative of a usefulness, an importance, a content level and/or any other feature of the message. The quality coding of graphical help interfaces in accordance with the present invention can be based on an unlimited number of visual differences between a shape, a color, a size, a content and/or any other visual characteristic of the graphical help interfaces. Furthermore, one or more specified features of an on-screen help message are quality coded (e.g., a usefulness of the message) via the graphical help interface and/or additional features of the on-screen help message can be customized to the user (e.g., the content of the message customized to a role and expertise level of the user).

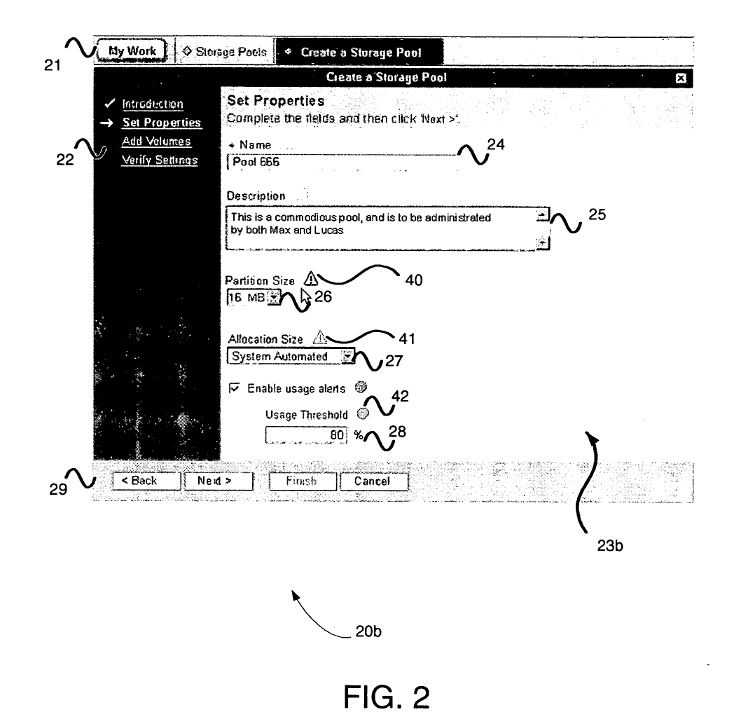

The following description of exemplary quality coded graphical help interfaces in the form of graphical help buttons as shown in FIGS. 2-12 is provided herein to facilitate an understanding of quality coded graphical hell) interfaces of the present invention. Those having ordinary skill in the art will appreciate from the exemplary help indicators and access buttons displayed in FIGS. 2-12 that, in practice, the quality coding of a graphical help interface in accordance with the present invention will be dependent to some degree upon the overall structure of an associated display window and the features of the on-screen help message, and are therefore without limit.

FIG. 2 illustrates a schematic of a display window 20b having three usefulness levels of help indicators integrated in corresponding access buttons 40-42 displayed in a panel 23b. A highly useful help indicator in button 40 is coded as bolded exclamation point within a bold triangle adjacent control 26 whereby an associated highly useful help message can be displayed for viewing by clicking help-access button 40. A moderately useful help indicator in button 41 is coded as an exclamation point within a triangle adjacent to control 27 whereby an associated moderately useful help message can be displayed for viewing by clicking button 41. A least useful help indicator within button 42 is coded as a circle with a small letter i adjacent to control 28 whereby an associated least useful help message can be displayed for viewing by clicking help-access button 42. The visual differences between indicators within buttons 40-42 distinguish the different usefulness levels of the associated help messages, respectively.

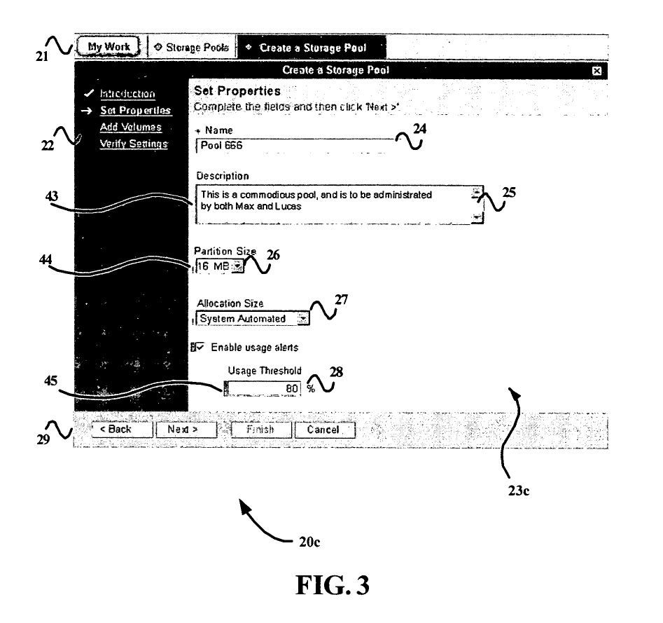

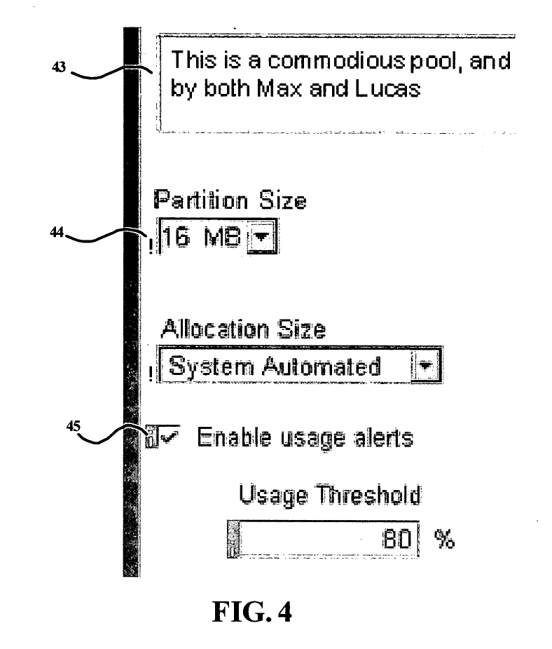

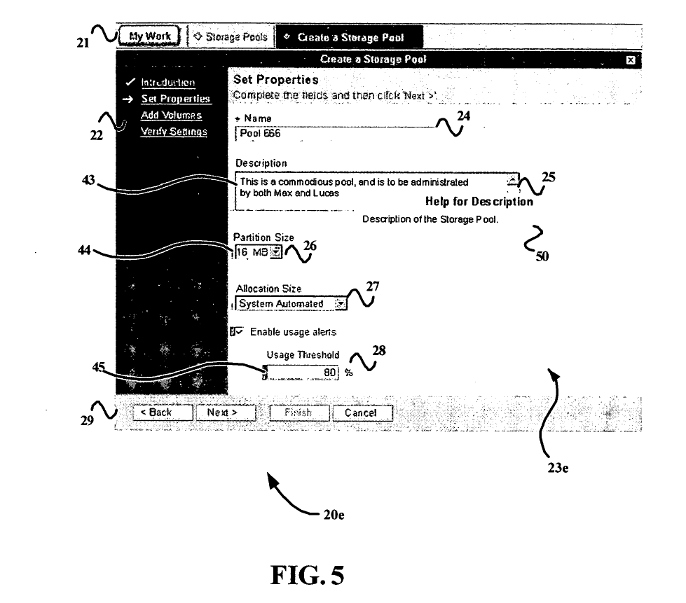

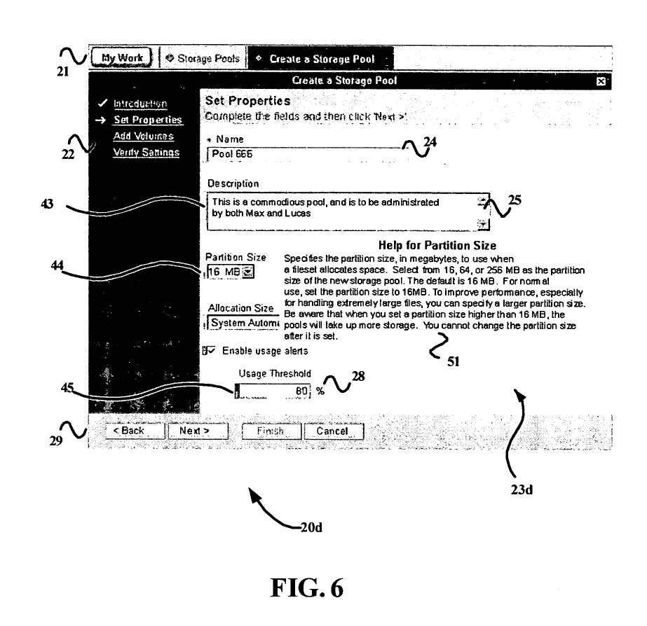

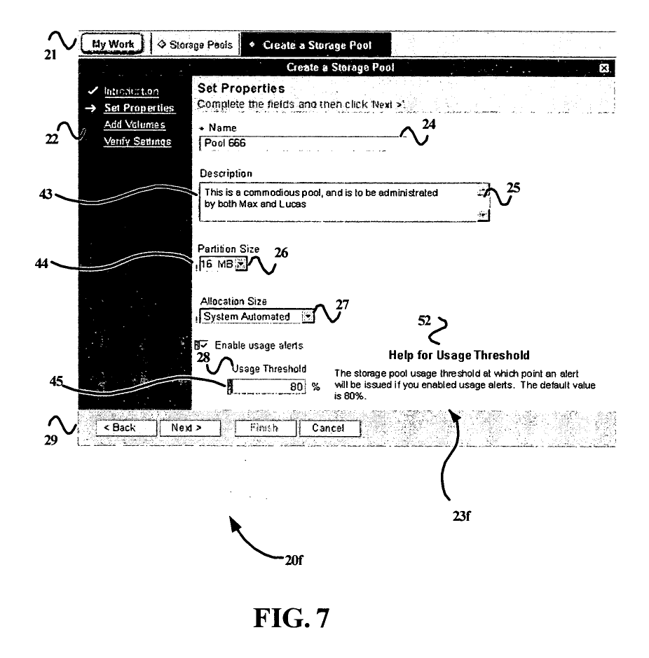

FIGS. 3 and 4 illustrates a schematic of a display window 20c having three usefulness levels of help buttons 43-45 displayed in a panel 23c. Whereas the help buttons 40-42 in FIG. 2 are nearby their corresponding panel controls 26-28, the help buttons 43-45 in FIGS. 3 and 4 are integrated more seamlessly and are adjoining their underlying panel controls 26-28. A button indicating least useful help 43 is coded as a rectangle adjacent control 25 whereby an associated least help message 50 can be displayed as exemplary illustrated in FIG. 5 for viewing by clicking button 43. A button indicating highly useful help 44 is coded as a bolded exclamation point within a rectangle adjacent control 26 whereby an associated highly useful help message 51 can be displayed as exemplary illustrated in FIG. 6 for viewing by clicking button 44. A button indicating moderately useful help 45 is coded as an “i” within a rectangle adjacent control 28 whereby an associated moderately help message 52 can be displayed as exemplary illustrated in FIG. 7 for viewing by clicking button 45.

As with help indicators in buttons 40-42 (FIG. 2), the visual differences between help levels indicated in buttons 43-45 distinguish the different usefulness levels of the associated help messages, respectively.

Three levels of usefulness have been illustrated in FIGS. 2 and 3. In alternative embodiments, more or less levels of usefulness can be used to distinguish the usefulness of help messages. For example, additional levels of usefulness can include a critical level of usefulness, an extreme level of usefulness, a very high level of usefulness, a high level of usefulness, a moderate level of usefulness, a somewhat useful level of usefulness, and a least useful level of usefulness. All the levels of usefulness may be indicated by gradations of visual impact to be correlated with all the levels of usefulness.

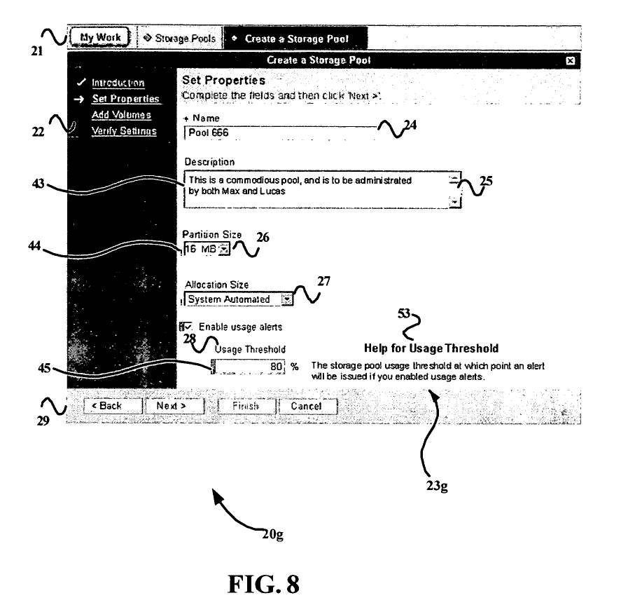

Additionally, a role of a user (e.g., a system monitor, a system administrator, or a system manager) and/or an expertise level of the user (e.g., novice, moderately skilled, highly skilled or expert) can vary a feature of the on-screen help message (e.g., content of the message) upon a clicking of one of the help buttons 40-45. For example, FIG. 7 illustrates the contents of an on-screen help message 52 as displayed in response to a clicking of help button 43 by a novice. FIG. 8 illustrates the contents of an on-screen help message 53 as displayed in response to a clicking of help button 45 by an expert.

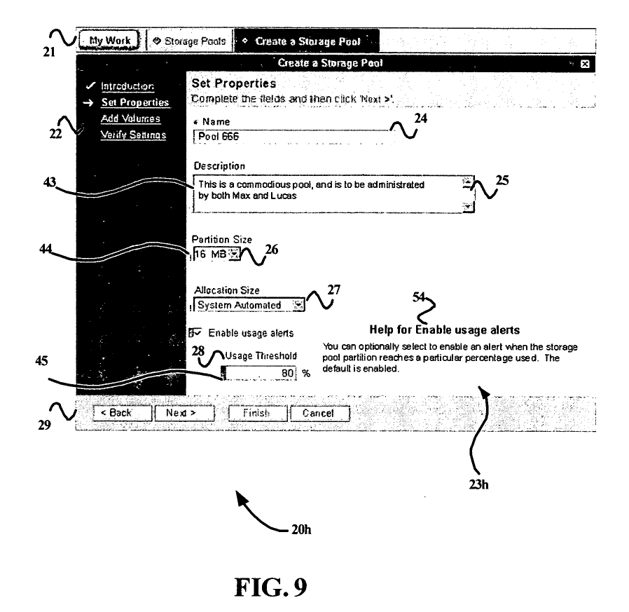

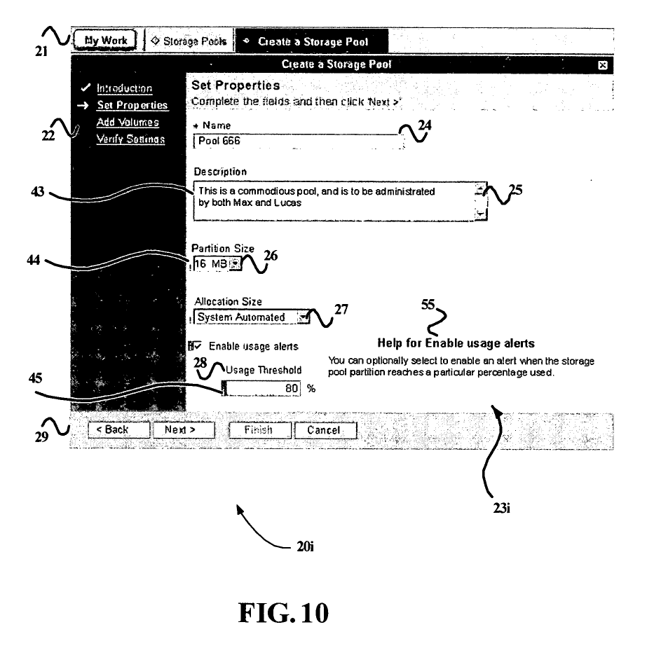

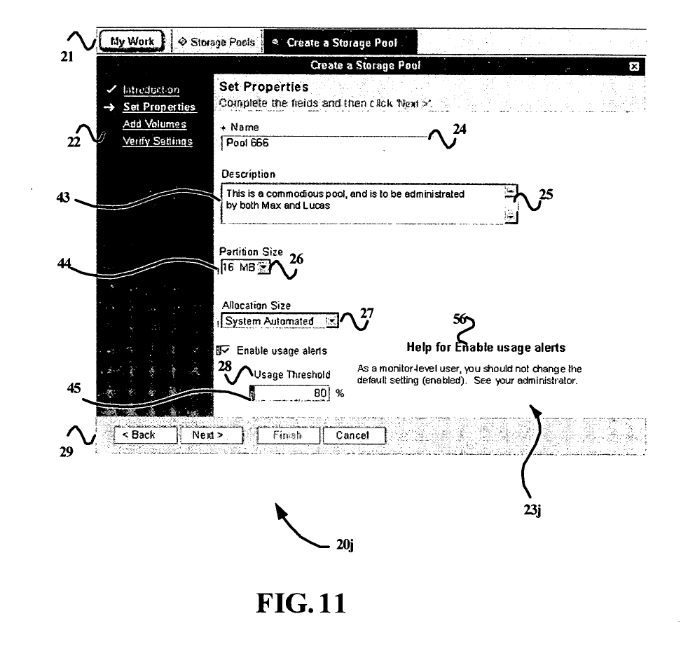

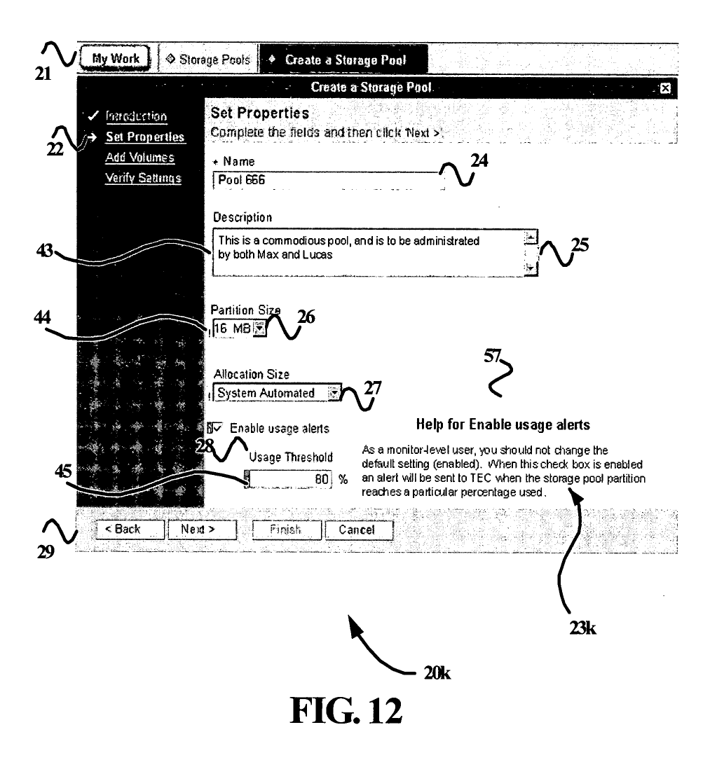

FIG. 9 illustrates the contents of an on-screen help message 54 as displayed in response to a clicking of help button 45 by a novice super manager. FIG. 10 illustrates the contents of an on-screen help message 55 as displayed in response to a clicking of help button 45 by an expert super manager. FIG. 11 illustrates the contents of an on-screen help message 53 as displayed in response to a clicking of help button 45 by a novice system monitor. And, FIG. 12 illustrates the contents of an on-screen help message 53 as displayed in response to a clicking of help button 45 by an expert system monitor.

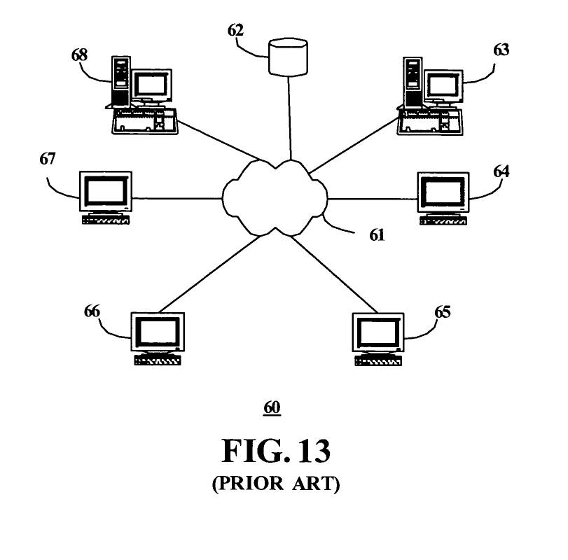

With reference now to a practical implementation of the present invention, FIG. 13 depicts a network of data processing system. Distributed data processing system 60 contains network 61, which is the media used to provide communications links between various devices and computers connected together within distributed data processing system 60. Network 61 may include permanent connections, such as wire or fiber optic cables, or temporary connections made through telephone or wireless communications.

In the depicted example, a server 63 and a server 64 are connected to network 61 along with a database 62. In addition, a client 65, a client 66, a client 67, and a client 68 are connected to network 61. Servers 63 and 64, and clients 65-68 may be represented by a variety of computing devices, such as mainframes, personal computers, personal digital assistants (PDAs), etc. Distributed data processing system 60 may includes additional servers, clients, networks, routers, and other devices not shown.

Distributed data processing system 60 may include the Internet with network 61 representing a worldwide collection of networks and gateways that use the TCP/IP suite of protocols to communicate with one another. Of course, distributed data processing system 60 may also include a number of different types of networks, such as, for example, an intranet, a local area network (LAN), or a wide area network (WAN).

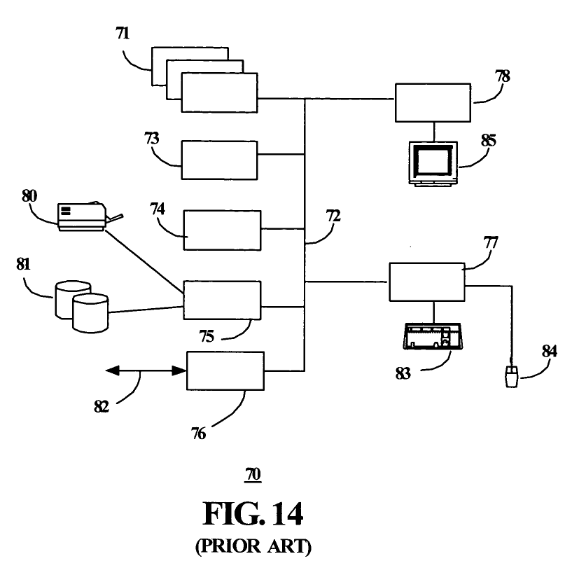

The present invention could be implemented on a variety of hardware platforms. FIG. 14 is intended as an example of a heterogeneous computing environment and not as an architectural limitation for the present invention.

With reference now to FIG. 14, a diagram depicts a typical computer architecture of a data processing system, such as those shown in FIG. 13, in which the present invention may be implemented. Data processing system 70 contains one or more central processing units (CPUs) 71 connected to internal system bus 72, which interconnects random access memory (RAM) 73, read-only memory (ROM) 74, and input/output adapter 75, which supports various I/O devices, such as printer 80, disk units 81, or other devices not shown, such as a sound system, etc. A communication adapter 76, a user interface adapter 77, and a display adapter 78 are also connected to bus 72. Communication adapter 76 provides bus 72 with access to a communication link 82. User interface adapter 77 connects bus 72 to various user input devices, such as keyboard 83 and mouse 84, or other devices not shown, such as a touch screen, stylus, etc. Display adapter 78 connects bus 72 to a display device 85.

Those of ordinary skill in the art will appreciate that the hardware in FIG. 14 may vary depending on the system implementation. For example, the system may have one or more processors, and other peripheral devices may be used in addition to or in place of the hardware depicted in FIG. 14. The depicted example is not meant to imply architectural limitations with respect to the present invention. In addition to being able to be implemented on a variety of hardware platforms, the present invention may be implemented in a variety of software environments, such as, for example, a programming of the present invention within or on a computer readable medium whereby a conventional operating system may be used to control program execution of the present invention within the data processing system. Those having ordinary skill in the art will appreciate various software languages that can be employed in writing software code for the various users interfaces of the present invention.

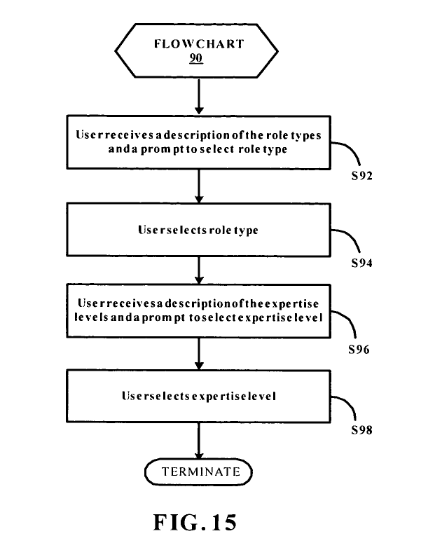

FIG. 15 illustrates a flowchart 90 representative of a method of user selection of expertise level. Software embodying flowchart 90 is installed on a data processing system (e.g., system 70 shown in FIG. 14) and initiated by a user of the system. During stage S92 of flowchart 90, the user receives a description of various role types for the user (e.g., system monitor, system administrator and system manager) and a prompt to select a role type. During stage S94 of flowchart 90, the user selects a role type that is consistent with a role of a person or persons primarily assigned to this particular system.

During a stage S96 of flowchart 90, the user receives a description of various expertise levels for the user (e.g., novice, moderately skilled, highly skilled and expert), and a prompt to select an expertise level. During a stage S98 of flowchart 90, the user selects an expertise level that is consistent with the expertise level of the person(s) primarily assigned to this particular system. Those having ordinary skill in the art will appreciate that, upon termination of flowchart 90, the contents of on-screen help messages will thereafter be customized to the selected role and expertise level of the person(s) primarily assigned to this particular system. Furthermore, those having ordinary skill in the art will appreciate that, upon termination of flowchart 90, the coding of graphical user interface can also be customized to the selected role and expertise level of the person(s) primarily assigned to this particular system. For example, help button 40 (FIG. 2) would be displayed adjacent control 26 (FIG. 2) for a novice system monitor while help button 42 (FIG. 2) would be displayed adjacent control 26 for an expert system manager.

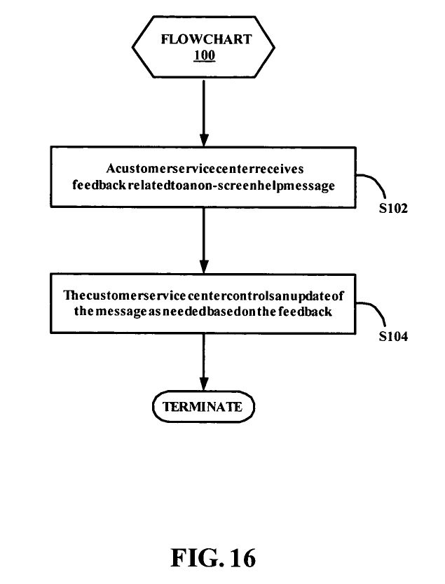

FIG. 16 illustrates a flowchart 100 representative of a method of dynamically updating the on-screen help messages which are displayed for the role and expertise levels of the person(s) primarily assigned to this particular system. Software embodying flowchart 100 is installed on a data processing system (e.g., system 70 shown in FIG. 14) and initiated by a customer service center of the system based on feedback, and possibly from many sources.

During stage S102 of flowchart 100, the customer service center receives feedback as to a viewing of an on-screen help message by the user(s) of a particular system. The mechanisms for providing feedback for the on-screen help message may come from phone calls to a software vendor's customer service center, posted comments by users on the software vendor's customer service center, or emails to the software vendor's customer service center. There also may be a feedback button correlated to the on-screen help message included in the software to allow the user to provide comments on the on-screen help message.

During stage S104 of flowchart 100, the customer service center controls an update, manually or automatically, as needed of the contents contained in the on-screen help message. An update, if needed, may be an expertise-level downgrade of the contents of the on-screen help message if displays of the message exceeds a pre-determined maximum display threshold. Conversely, the update, if needed, may be an expertise-level downgrade of the contents of the on-screen help message if displays of the message fails to exceed a pre-determined minimum display threshold. Those having ordinary skill in the art will appreciate that, upon termination of flowchart 100, the on-screen help message will be dynamically displayed for expertise levels of the person(s) primarily assigned to this particular system based on the feedback.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A method in a data processing system for providing a user of the data processing system with a visual indication of a quality of a first feature of an on-screen help message, the method comprising:
generating a graphical help interface as a visual indication of a quality of the first feature of the on-screen help message; and
displaying the graphical help interface in a display window associated with the on-screen help message.

2. The method of claim 1, wherein the visual indication of the graphical help interface is at least one of a shape coding, a color coding, a size coding, and a content coding.

3. The method of claim 1, wherein the graphical help interface is displayed in the display window adjacent at least one of a text and graphics associated with the on-screen help message.

4. The method of claim 1, wherein the first feature of the on-screen help message is one of a usefulness, an importance, or a content level of the on-screen help message.

5. The method of claim 1, further comprising:
customizing the first feature of the of the on-screen help message to the user of the data processing system.

6. The method of claim 1, further comprising:
customizing a second feature of the of the on-screen help message to the user of the data processing system.

7. The method of claim 6,
wherein the first feature of the of the on-screen help message is a usefulness of the on-screen help message; and
wherein the second feature of the of the on-screen help message is a content of the on-screen help message.

8. The method of claim 1, further comprising:
receiving feedback related to a viewing of the on-screen help message by the user; and
controlling an update of the message based on the feedback.

9. A signal bearing medium tangibly embodying a program of machine-readable instructions executable by a processor to perform operations to visually indicate a quality of a first feature of an on-screen help message, the operations comprising:
generating a graphical help interface as a visual indication of a quality of the first feature of the on-screen help message; and
displaying the graphical help interface in a display window associated with the on-screen help message.

10. The signal bearing medium of claim 9, wherein the visual indication of the graphical help interface is at least one of a shape coding, a color coding, a size coding, and a content coding.

11. The signal bearing medium of claim 9, wherein the graphical help interface is displayed in the display window adjacent at least one of a text and graphics associated with the on-screen help message.

12. The signal bearing medium of claim 9, wherein the first feature of the on-screen help message is one of a usefulness, an importance, or a content level of the on-screen help message.

13. The signal bearing medium of claim 9, wherein the operations further comprise: customizing the first feature of the of the on-screen help message to a user of the program.

14. The signal bearing medium of claim 9, wherein the operations further comprise: customizing a second feature of the of the on-screen help message to a user of the program.

15. The signal bearing medium of claim 14,
wherein the first feature of the of the on-screen help message is a usefulness of the on-screen help message; and
wherein the second feature of the of the on-screen help message is a content of the on-screen help message.

16. The signal bearing medium on claim 9, wherein the operations further comprise:
receiving feedback related to a viewing of the on-screen help message by a user of the program; and
controlling an update of the message based on the feedback.

17. A data processing system, comprising:
a display;
a processor; and
memory storing instructions operable with the processor for visually indicating a quality of a first feature of an on-screen help message, the instructions being executed for:
generating a graphical help interface as a visual indication of a quality of the first feature of the on-screen help message; and
displaying the graphical help interface in a display window associated with the on-screen help message.

18. The data processing system of claim 17, wherein the visual indication of the graphical help interface is at least one of a shape coding, a color coding, a size coding, and a content coding.

19. The data processing system of claim 17, wherein the graphical help interface is displayed in the display window adjacent at least one of a text and graphics associated with the on-screen help message.

20. The data processing system of claim 17, wherein the first feature of the on-screen help message is one of a usefulness, an importance, or a content level of the on-screen help message.

21. The data processing system of claim 17, wherein the instructions are further executed for customizing the first feature of the of the on-screen help message to the user of the data processing system.

22. The data processing system of claim 17, wherein the instructions are further executed for customizing a second feature of the of the on-screen help message to a user of the data processing system.

23. The data processing system of claim 22,
wherein the first feature of the of the on-screen help message is a usefulness of the on-screen help message; and
wherein the second feature of the of the on-screen help message is a content of the on-screen help message.

24. The data processing system of claim 17, wherein the instructions are further executed for receiving feedback related to a viewing of the on-screen help message by a user of the data processing system and for controlling an update of the message based on the feedback.
